(19) United States
(12) Patent Application Publication
(10) Pub. No.: US 2008/0046114 A1
(43) Pub. Date: Feb. 21, 2008

(54) SYSTEM, PACKAGING, AND METHOD FOR DISTRIBUTING PRODUCTS

(76) Inventors: Charles A. White, Oakland, CA (US); Paul Atkinson, Poway, CA (US)

Correspondence Address: WILLIAM J. KOLEGRAFF, 3119 TURNBERRY WAY, JAMUL, CA, 91935, US

(21) Appl. No.: 11/464,550

(22) Filed: Aug. 15, 2006

(51) Int. Cl. G06F 7/00

(52) U.S. Cl. 700/215

(57) ABSTRACT

A method and system for communicating a product status is provided. The product has a product indicator device that has a changeable indicator, an embedded processor, and radio. A point of sale device wirelessly reads validation data from the embedded processor, with the validation data being used to confirm that the product may validly change states. If the product is allowed to have its state changed, the point of sale device sends a key code to the embedded processor, where the key code is processed with locally stored data. The embedded processor determines if the changeable indicator may be changed to show that the product has changed states.

### BACKGROUND

The present invention relates to systems, packaging, and processes for distributing products. In a particular example, the invention relates to packaging and distribution methods for products having a defined expiration date or other distribution rule.

Manufacturers face a difficult problem in managing their distribution chains to assure products are safely and properly delivered to consumers. The manufacturer typically uses a distribution chain and retailers to bring its products to consumers. Often, the manufacturer must rely on the integrity and honesty of its distributors and retailers to assure that their products are properly sold or otherwise delivered. Building and maintaining such a trusted relationship with distributors and retailers is time consuming and takes considerable effort and resource to monitor. The ability to build and maintain a trusted distribution network is important to all manufacturers, and is particularly critical in some product fields. For example, some products, such as foods, pharmaceuticals, supplements, chemicals, and cosmetics have a limited useful life, and so must be sold to consumers prior to an expiration date. Typically, the expiration date for products is printed on a package, often in relatively small print and in an obscure area. Accordingly, consumers are often likely to fail to notice the expiration date, and therefore may inadvertently purchase an expired product. Also, the retailer has typically paid for their inventory of goods, and products that are expired are typically discarded, and therefore can be a great expense to the retailer. To reduce this expense, retailers have an economic incentive to continue to offer goods for sale, and sell those goods to consumers, even when expired.

But selling an expired product may lead to customer dissatisfaction, or worse, an injury or death. Accordingly, the liability for a mis-sold product may be extraordinary, and with current product liability laws, a damage award may be held against everyone in the distribution chain from the manufacturer to the final retailer. It is therefore in the best interest of the manufacturer, the consumer, and the retailer to assure that products are properly sold. In another example, it is desirable to sell a product, such as a software product, that is not usable until the consumer enters a password, or otherwise can show that they are authorized to operate the software. However, current software management tools typically involve requiring the user to register the software to obtain a license key, or to install the software and then perform an on-line activation. These processes require annoying and time consuming steps for the consumer, as well as a software management process maintained by the manufacturer.

Challenges also exist for non-commercial distribution of goods. For example, the military stores, transports, and maintains weapons and gear that is subject to expiration. When distributing these goods, it is vital that weapons, explosives, or other military gear not be expired.

### SUMMARY

The present invention provides a method and system for communicating a product status. The product has a product indicator device that has a changeable indicator, an embedded processor, and a radio. A point of sale device wirelessly reads validation data from the embedded processor, with the validation data being used to confirm that the product may validly change states. If the product is allowed to have its state changed, the point of sale device sends a key code to the embedded processor, where the key code is processed with locally stored data. The embedded processor determines if the changeable indicator may be changed to show that the product has changed states.

In one example, the present invention provides a label on a product. The label includes a changeable indicator, an embedded processor, and radio. A point of sale device uses an RF (Radio Frequency) or NFC (Near Field Communication) device to read validation data from the embedded processor, with the validation data being sent to a network operation center. The network operation center applies rules to the data, and determines if the product may validly change states. If the product is allowed to have its state changed, the network operation center retrieves, generates, or extracts a key code and sends the key code to the point of sale device, which sends the key code to the embedded processor. The embedded processor processes the key code with locally stored data and determines if the changeable indicator may be changed to show that the product has changed states. If so, the embedded processor uses a power source to change the changeable indicator. The indicator may be used to communicate information to the consumer, for example, if the product is sold prior to its expiration date, or an activation code or password.

Advantageously, the present invention may be used to provide a consumer with trusted and authenticated information at a point of sale location, which may be a retail establishment, a vending machine, a kiosk, or an at-home activation location. In this way, the manufacturer of a product may be confident that their product is being properly sold, and that correct and important product information is being timely and accurately communicated to its customers. By enabling this communication path directly to the customer, the manufacturer is able to more effectively maintain distribution integrity.

### BRIEF DESCRIPTION OF DRAWINGS

FIG. 1 is a diagram of a product indicator device in accordance with the present invention.

FIG. 2 is a flowchart of a process for validating and confirming a change in product status in accordance with the current invention.

FIG. 3 is a flowchart of a process for validating and confirming a change in product status in accordance with the current invention.

FIG. 4 is a flowchart of a process for validating and confirming a change in product status in accordance with the current invention.

FIG. 5 is a diagram of a product label device in accordance with the present invention.

FIG. 6 is a flowchart of a process for validating and confirming a change in product status in accordance with the current invention.

FIG. 7 is a diagram of a product label device in accordance with the present invention.

### DETAILED DESCRIPTION

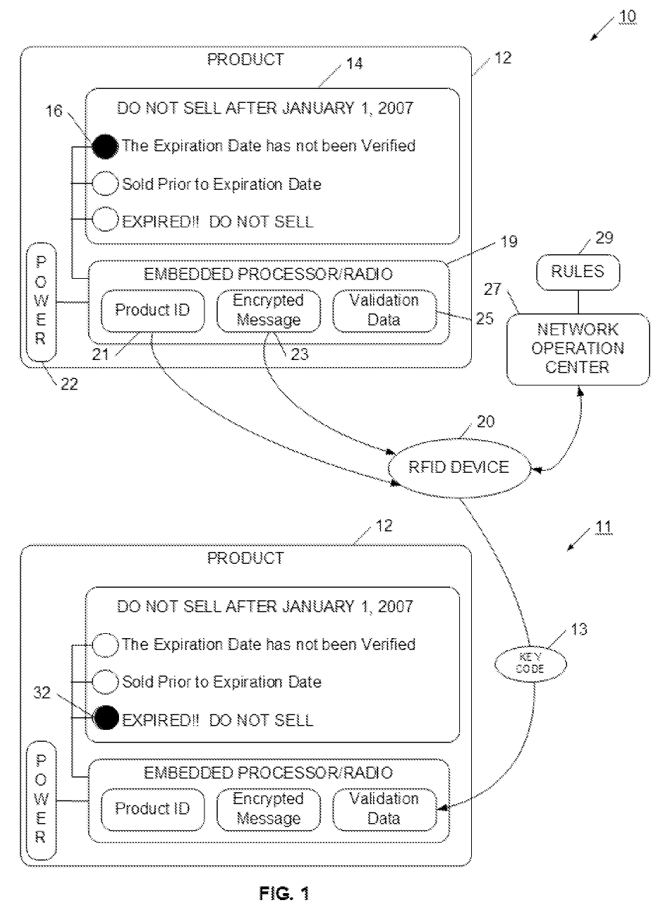

Referring now to FIG. 1, product indicator system 10 is illustrated. Product indicator system 10 may be advantageously used to provide a consumer with trusted and authenticated information at a point of sale location. In this way, the manufacturer of a product may be confident that their product is being properly sold, and that correct and important product information is being timely communicated to its customers. By enabling this communication path directly to the customer, the manufacturer is able to more effectively maintain distribution integrity. In one example, product indicator system 10 enables a manufacturer to validate the conditions under which a product is allowed to be sold to a consumer, and to visually inform the consumer whether or not the product may be sold safely. As illustrated in FIG. 1, product 12 has a product indicator in the form of label 14. Product 12 may be, for example, a jar of baby food, a pharmaceutical, or a bottle of milk. It will be appreciated that any consumer, commercial, and military product may be used. Label 14 may be fixedly attached to product 12, or may be integrally formed with the product. As illustrated, label 14 is attached to product 12, and has textual descriptions for informing a consumer of the products state. More specifically, label 14 indicates whether: 1) the expiration date has not been verified, 2) the product has been properly sold prior to an expiration date, or 3) the product has expired and should not be sold. To indicate to the consumer the proper product state, a set of changeable indicators is provided, including changeable indicator 16. In its initial state, the changeable indicators may be set to indicate that the expiration date for the product has not been verified. This would be the state, for example, that the product would exhibit while on a retail shelf.

Label 14 is connected to embedded processor and radio system 19. Embedded processor and radio system 19 includes a receiver and transmitter for communicating with point-of-sale radio device 20. Point-of-sale radio device 20 may be, for example, an RF system for retrieving data from the embedded processor and sending validated data back to the embedded processor. In another example, the point-of-sale device may include a near-field-communication (NFC) device. Embedded system 19 may be integrally formed with the label, or may be otherwise provided in or on the product. Embedded processor system 19 cooperates with an associated point of sale RF device 20, and with network operation center 27 to confirm that the product is in a state for sale, and for setting the changeable indicators to visually announce the product's state. By employing a secured and authenticated communication and validation process, the product's state may be confidently determined and communicated to the consumer.

Embedded processor and radio system 19 may also hold product ID value 21 and encrypted message 23. Product ID 21 and encrypted message 23 may be communicated to a network operations center and used in determining the current state of product 12. Embedded processor 19 also has secret validation data 25 which is locally used by the embedded processor for authenticating communications and validating the product state. Preferably, secret data 25 is stored in a way that is externally inaccessible and unalterable.

In one example of use, product 12 is taken by a consumer from a retail shelf to a point-of-sale terminal. A clerk may scan product 12 using RFID device 20. RFID device 20 cooperates with radio system 19 to retrieve product ID 21, as well as encrypted message 23. RFID device 20 passes product ID 21 and encrypted message 23 to network operations center 27. Network operations center 27 may be local to the retail environment, or it may be remotely located. Network operation center 27 uses product ID 21 to retrieve the decryption key associated with that product. Using this decryption key, network operations center 27 decrypts encrypted message 23. Encrypted message 23 may have specific information regarding product 12, which may include the expiration date of product 12. The network operations center compares the current date to the date extracted from the encrypted message 23, and determines whether product 12 may be properly sold. More specifically, the network operations center has rules 29 which are to be applied to product 12. As illustrated, these rules may include rules concerning expiration, but other rules may be applied. For example, rules may be used which define particular geographies, types of retailers, date ranges, time ranges, or other rules that may apply to product validity.

After comparing the information extracted from the encrypted message to rules 29, network operations center 27 determines whether product 12 may be validly sold. According to this determination, network operations center 27 generates key code 13 and sends key code 13 to RFID device 20. RFID device 20 communicates key code 13 to embedded processor system 19. Embedded processor system 19 has stored validation data 25, which is locally processed with key code 13 to determine if the product may be validly sold. If the product is ready for a valid sale, network operation center 27 generates key code 13 to allow embedded processor 19 to authenticate the pending sale. However, if the product is not-ready for valid sale, network operation center 27 generates key code 13 to cause embedded processor 19 to indicate that the product should not be sold. To reduce the opportunity for an unscrupulous retailer to spoof the validation process, the “good” codes and the “bad” codes are sent in a form such that analysis of the code does not allow a determination of whether a validating or invalidating code has been sent. In this way, only processes operating in embedded processor 19 are able to determine whether key code 13 is a “good” code or a “bad” code.

In a specific example, validation data 25 is a secretly stored value such as a random number. That is, validation data 25 is stored in the embedded processor memory in a way that is unalterable and not externally readable or otherwise accessible. Network operation center 27 is aware of the specific value stored in embedded processor 19. In one example, network operation center 27 has a database that associates product ID values with their respective stored validation data, or has an algorithmic process for determining the stored value. In another example, encrypted message 23 includes an encrypted version of validation value 25. By decrypting message 23, network operation center 27 obtains the proper “good” key for product 12. This latter process thereby avoids having to store and maintain a database of key codes, and instead allows the product itself to maintain the code. Since network operation center knows the “good” validation value stored at the product, it will send that value in the case the sale should proceed, and send a different value if the sale should not proceed.

If the value returned as key code 13 matches validation data 25, then embedded processor 19 determines that product 12 has not expired. In such a case, embedded processor 27 uses power source 22 to change the changeable indicators to indicate that product 12 has been properly sold prior to its expiration date. In another example, network operations center 27 may determine that product 12 has expired, and therefore sends a key code that when processed with validation data 25 causes the embedded processor to change the changeable indicator to show that the product has expired. As shown in FIG. 1, embedded processor 19 has applied power to changeable indicator 16 to indicate that the expiration date has been checked, and causes changeable indicator 32 to indicate that the product has expired and should not be sold. Although FIG. 1 illustrates three changeable indicators, it will be understood that more or fewer changeable indicators could be used. For example, a single changeable indicator could be used that changes from a yellow to red in the case that the product has expired, or changes from yellow to green when the product is safe for sale. Co-pending U.S. patent application Ser. No. 11/296,081, filed Dec. 7, 2005, and entitled “Device and Method for Selectively Controlling the Utility of a Target” provides further descriptions of an embedded processor system and an associated network operation center, and is incorporated herein by reference in its entirety.

The authentication and validation system and process just described provides a secure and robust process for informing consumers of a product state. Further, the manufacturer may be confident that its products are properly sold, and that important information is being accurately conveyed to consumers. In some situations, however, a less robust and secure process may be sufficient. In these cases, a simplified process may be used. For example, RFID device 20 may only need to retrieve product ID 21 so that the network operations center can look up rules associated with that specific product or class of product. On confirming that the product has satisfied the rules, the network operations center may generate a key code so that RFID device 20 can send a key code to embedded processor 19. In this case, rules 29 can be applied without specific product data being passed to network operations center 27. In another example, RFID device 20 may retrieve only encrypted message 23 from the embedded processor, and network operations center 27 may use the encrypted message to extract product information. Provided the product information complies with rules 29, network operations center 27 generates a key code and passes the key code to embedded processor 19 for further processing. In yet another example, the product information is not stored in an encrypted form, but is stored in a plaintext form. The RFID device may then extract the plaintext product data, and pass that data to the network operations center. The plaintext product information may then be compared to rules, and provided the rules are met, the key code may again be generated. It will be appreciated that the structure and process for the product indicator system 10 is highly flexible, and therefore may be practically implemented in many specific embodiments.

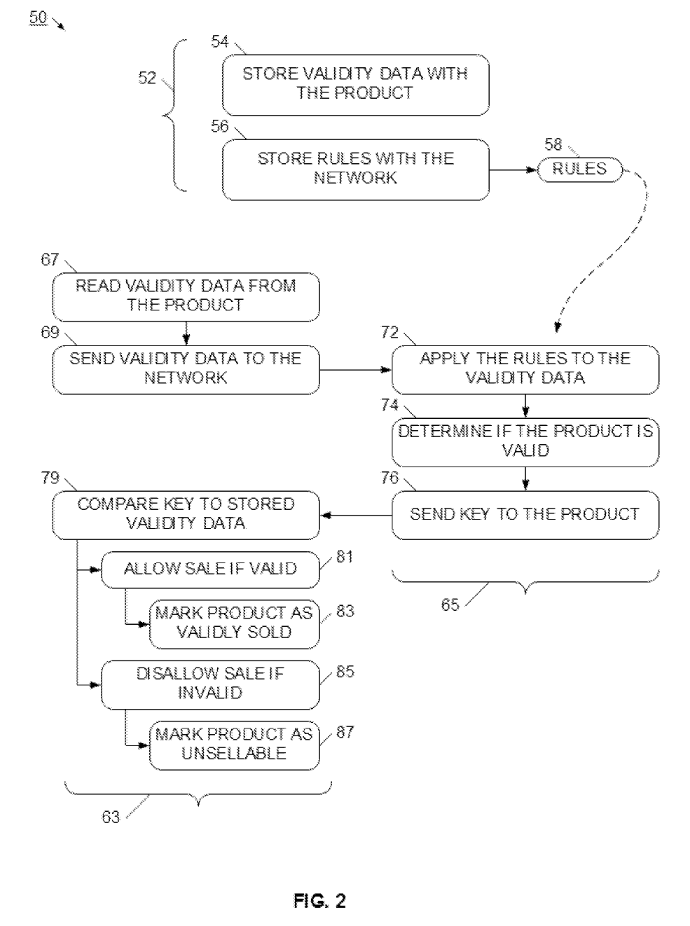

Referring now to FIG. 2, a method for validating and confirming a change in product status in illustrated. For example, the change in status may be a product transfer or a sale to a consumer. Method 50 has some preliminary actions 52, which are taken by the manufacturer prior to distributing a product through a distribution channel. These actions 52 include storing validity data with the product as shown in block 54. This validity data may include multiple data items, and may take a form of a code or value, such as a random number, and may also include various encrypted and plaintext messages. This validity data may further include some data or values stored in the product in an externally unreadable and unalterable form, such that any attempt to read or alter the data or values will disable or destroy the data. In one example, the validity data is stored in an embedded processor that is included on a label attached to the product, or that is integrally formed with the product. The embedded processor also couples to a changeable indicator on the product, such that a consumer may be made aware of a product state. On the network side 65, rules 58 are associated with the product and stored on the network as shown in block 56. These rules 58, may include rules associated with expiration, geography, allowed distributors, passwords, license keys, allowed times, or other product validity rules.

When the product is ready for validation, such as when a consumer moves the product to a point-of-sale terminal, selected value(s) of validity data are read from the product as shown in block 67. This validity data may be read, for example, by an RF device in the point-of-sale terminal. It will be appreciated that other RF devices may be used depending upon a specific point of contact with the product. For example, if a product is being activated in a vending machine, then the RF device may be associated with the vending machine mechanics. If the product is being interrogated at a home environment, then the RF communication may be using an RF reader connected to a consumer's home computer system, which connects to a network operations center through the Internet. It will also be understood that near field communication systems may also be used for reading the validity data. This validity data may be provided in alternative ways. For example, the validity data values may be provided as a product ID, an encrypted message, or a plaintext message. The encrypted messages may include information regarding the product, such as expiration date, or may include information about the secret code, such as a random number. In some cases, the validity data may include multiple values, such as both a product ID and an encrypted message. In other cases, less security authentication is needed, so fewer data items may be used.

After the validity data values have been read from the product, the validity data values are sent to a network operations center as shown in block 69. This network operations center may be local to the retail environment, or more likely is hosted at a remote site. The network operations center receives the validity data, performs any required decryptions, and applies the rules 58 to the validity data as shown in block 72. For example, the rules 58 may state that the product may not be sold after an expiration date, with the expiration date being provided in the validity data received from the product. By applying the rules 58 to the validity data received from the product, the network operations center may determine if the product may be validly sold as shown in block 74. For example, the network operations center may decrypt the validity data to extract an expiration date for the specific product. The expiration date received from the product may be compared to a current date, and if the expiration date has not passed, may determine that the product may be validly sold. If the expiration date has passed, then the network operations center may determine that the product may not be validly sold. Depending on the outcome of the network processes 65, a key code is generated and sent to the product 70 as shown in block 76. The key codes are assembled and communicated in a way that, if intercepted, an analysis of the key codes will not reveal if the key code indicates a valid or invalid product state. It is only by processing within the embedded processor that such a determination is made.

In a specific example, the validity data values sent to the network operation center include both a product ID and an encrypted message that includes an expiration date. The network operations center uses the product ID to retrieve a key code that matches validation data previously stored on the product. Alternatively, the encrypted message may also include an encrypted version of the “good” key code. In this way, the network operations center can decrypt the message to obtain the key, and thereby not have to maintain stored key codes. This key code may be, for example, a random number.

Provided the retrieved expiration date has not passed, the network operations center may then use the retrieved or decrypted key code as the code to be sent back to the product. If the expiration date has passed, another code may be sent for indicating that the product expiration date has passed. The key codes are assembled and communicated in a way that, if intercepted, an analysis of the key codes will not reveal if the key code indicates a valid or invalid product state. It is only by processing within the embedded processor that such a determination is made. The key code is then sent to the product, where certain product processes 63 are performed. More particularly, the network operation center sends the key code to the point-of-sale RF device, which then wirelessly transmits the code to the embedded processor on the product. For example, the embedded processor in the product may receive the key code from the RF device, and compare the received code to stored validation data as shown in block 79. As described above, this stored validation data may be a random number, and if the number received from the network matches the stored random number, then the embedded processor will determine that the sale is valid as shown in block 81. If the sale is valid, the embedded processor uses a power source to set an indicator that marks the product as validly sold as shown in block 83. For example, the embedded processor may use a power source to switch a changeable indicator to indicate that the product has been validly sold. In a similar way, if the key code received from the network does not match the validation data stored at the embedded processor, then the sale is not valid as shown in block 85. In such a case, the embedded processor may use a power source to switch a changeable indicator to indicate to the product should not be sold as shown in block 87. It will be appreciated that the power source may be, for example, a battery stored with the embedded processor, or may be an antenna and power conversion circuitry for converting a received RF signal or EM (electromagnetic) signal to a power signal. These power signals may be applied to the changeable indicator to change the indicator according to the validation determination. In one example, this changeable indicator is an electro-chromic material that changes colors or densities depending upon power applied.

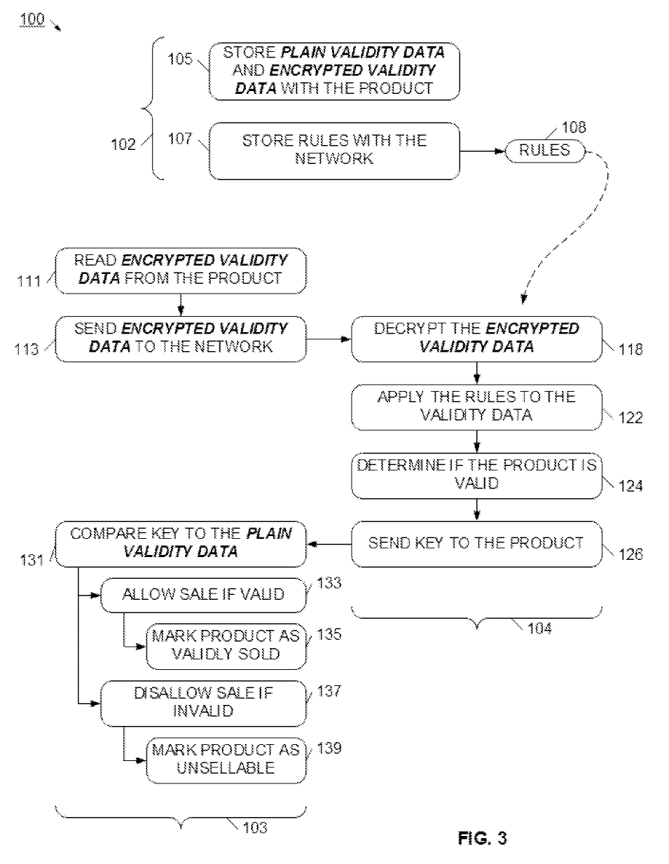

Referring now to FIG. 3, a method for validating and confirming a change in product status is illustrated. Method 100 includes activities 102 which are performed prior to distributing the product through a distribution channel. Activities 102 include storing with the product a plain validity data and an encrypted validity data as shown in block 105. This data may be stored with the product in an embedded processor attached to a label, or alternatively, integrally formed with the product. In one example, the plain validity data is unencrypted and stored in a memory that is externally inaccessible and unalterable at the product. The encrypted validity data may be, for example, an encrypted expiration date, an encrypted code key, or both. The expiration date is encrypted using an encryption key specific to the product or class of products, such that the encrypted validity data may only be unencrypted using an associated decryption key at a later time. It will also be understood that a product identifier may also be stored with the product, with product ID assisting with associating the decryption key with the specific product or class of products. In this way, the decrypting network process may more efficiently determine which decryption key to use.

Rules 108 are also stored at a network operations center as illustrated in block 107. These rules contain validation and confirmation rules, such as a rule that states a product may only be validly sold prior to its expiration date. It will be appreciated that other rules regarding times, places, and conditions of sale may be used. These rules 108 are stored with the network operations center, and may be associated with the product or product ID. The network may also store product ID information, decryption key information, as well as code key information.

When the product is presented for sale at a point-of-sale terminal, certain activities occur at the point-of-sale 103, while other activities occur at a corresponding and cooperating network operations center 104. At the point-of-sale location the encrypted validity data is read from the product as shown in block 111. Alternatively, the product ID may also be read from the product, which, as stated above, may enable the network operations center to more efficiently decrypt and validate the validity data. The point-of-sale terminal sends the encrypted validity data to the network as shown in block 113. It will be appreciated that the point-of-sale terminal may have an RF device, such as an RFID reader, for reading the encrypted validity data and product ID from the product, or may use an near field communication device. The point-of-sale terminal is connected to a network connection that couples to a network operations center where rules 108 are stored. The network operations center receives the encrypted validity data 118, and either through algorithmic processes, or by associating a key with a product ID, decrypts the validity data. In the case where the encrypted validity data is an expiration date, the encrypted validity data is decrypted to expose an expiration date. The expiration date is compared to the current date according to the rules for that product as shown in block 122. Provided the product is valid as shown in block 124, the network operations center retrieves a key code for the product as shown in block 126. In the case where the encrypted validity data includes a key code, the encrypted validity data is decrypted to expose a “good” key code. This key is then transmitted through the network and the RF point-of-sale device to the product. It will be appreciated that if the product is not valid to be sold, then a null or different key may be sent. However, it is desirable that any interceptor not be able to discern whether the transmitted key code indicates a valid or invalid sale.

The product has an embedded processor which processes the received key code with the secret plain validity data as shown in block 131. In one case, the validity data may simply be a random number, and if the stored random number is the same as the received key code, the embedded processor is aware that an authenticated approval has been made. In such a case the embedded processor may allow the sale as being valid as shown in block 133, and enable processes to visually mark the product as validly sold as shown in block 135. For example, the embedded processor may use a power source to send a power signal to an electro-chromic material, for activating an indicator showing the product as validly sold. However, if the received key and the stored validity data do not match, then the product may not be validly sold as shown in block 137. In this case, the embedded processor may proceed to activate processes to mark the product as being unsellable as shown in block 139. For example, a power supply may be used to send a power signal to electro-chromic material to activate an indicator on a label that shows that the product is unsellable.

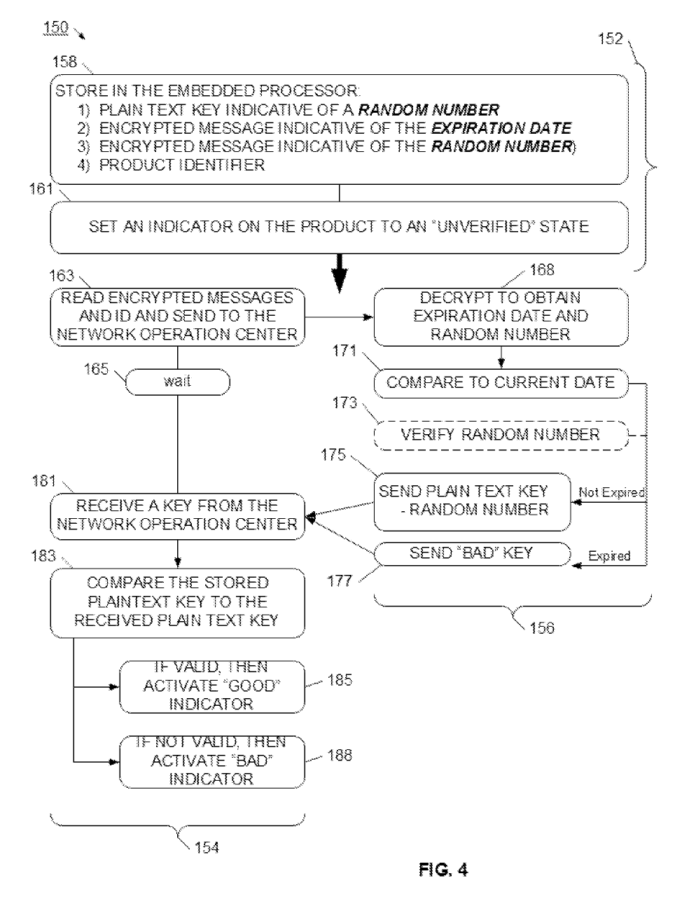

Referring now to FIG. 4, a method for validating and confirming a change of status for a product is illustrated. In method 150, a plain text key indicative of a random number is stored in a secret location as shown in block 158. This location is unreadable from external sources, and is unalterable. An encrypted message indicative of the expiration date is also stored in the embedded processor as shown in block 158. Optionally, the encrypted message may also have information indicative of the random number. It will be appreciated that other data and ID information may also been stored with the embedded processor to assist in authentication decryption, and validation processes. The embedded processor may be attached to a product in the form of a label, or may be integrally formed with the product. Initially, the product has an indicator device that visually sets indicia on the indicator to show an unverified state as shown in block 161. For example, the product indicator may have an area of the label set to a yellow cautionary color, or may illuminate a dot next to a textual or iconic passage indicating that the product has not been verified.

When the product is moved to a point-of-sale terminal, the point-of-sale terminal uses an RF device to read the encrypted message from the product and send the encrypted message to a network operations center as shown in block 163. The point-of-sale terminal then waits as shown in block 165, or proceeds to collect other information needed from the consumer to consummate the sale. The network operations center decrypts the encrypted message to obtain the expiration date as shown in block 168. The network operation center may algorithmically determine the proper decryption key, for example by sequentially applying possible decryption keys, or may use other product data to identify a specific or small set of decryption keys. The decrypted message has information regarding the expiration date of the product. The network operations center then applies a rule to compare the current date to the decrypted expiration date as shown in block 171. In some cases, the random number may also have been encrypted within the encrypted message, and if so, the random number may be verified as shown in block 173. This optional step further authenticates and secures the validation process. This random number is like the random number plaintext key that is secretly stored in the embedded processor, and so may be used as the “good” or valid key code.

If the product is being sold prior to its expiration date, the plain text key indicative of the random number will be sent as shown in block 175. However, if the network determines that the date has expired, or cannot authenticate the process, then a bad or null key is sent as shown in block 177. These network operations 156 are thereby used to authenticate the transaction as well as validate and confirm that the product is in proper state for sale. At the point-of-sale 154, the key code is received from the network operations center as shown in block 181. The key code is wirelessly transmitted from the point of sale terminal to the embedded processor using, for example, an RFID device. The received key is compared to a plain text key stored within the embedded processor as shown in block 183. Although a simple comparison is contemplated, it will be understood that more sophisticated logic may be applied. If the plain text key matches the received key, then the embedded processor uses a power supply to activate a “good” indicator as shown in block 158. However, if the plain text key does not match the received key, then the embedded processor uses the power supply to activate a “bad” indicator as shown in block 188. It will be appreciated that the indicator may be, for example, an electro-chromic material that changes color or density or reflectivity based on its state. It will also be appreciated that the embedded processor and the power to change the indicator may be provided by converting RF or EM (Electro-magnetic) energy to local power. Co-pending U.S. patent application No. 60/783,705, filed Mar. 17, 2006, and entitled “An RFID System for Providing Data and Power”, describes structures and process for converting RF and EM signals to usable local power, and is incorporated herein by reference in its entirety.

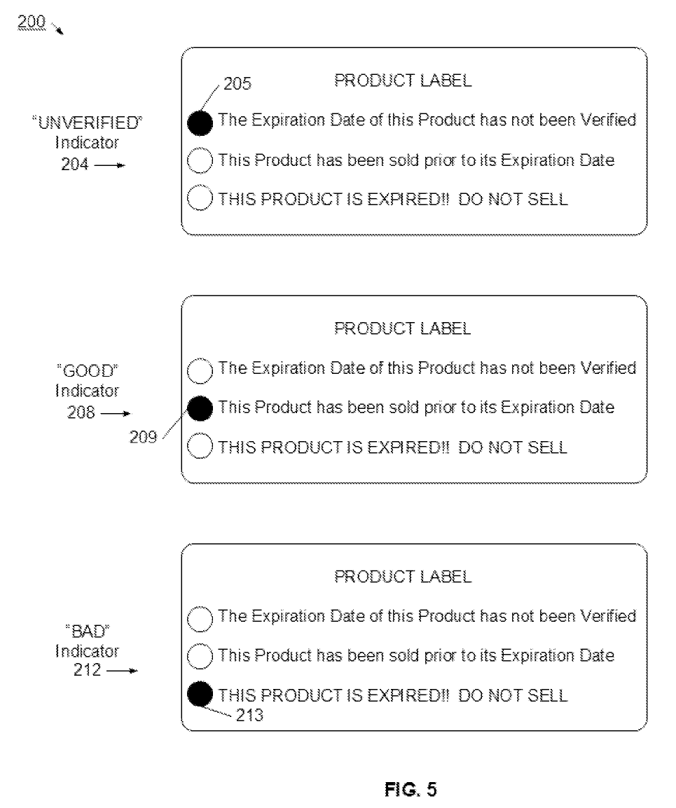

Referring now to FIG. 5, product indicator device 200 is illustrated. Product indicator device 200 is in the form of a product label for attachment to a product. This product label may be affixed to the product using, for example adhesives, or may be integrally formed with the product. The product label may include the embedded processor integrated circuit, as well as an RF radio and antenna. It will also be appreciated that the product label may be separate from the embedded processor, radio, and antenna and coupled to those devices using lines or traces. As illustrated, the product label has an unverified indicator 204, which has a changeable indicator 205 in a dark state when the product has not been verified. When the product has gone through a point-of-sale terminal, the indicator 205 is switched to a transparent state. In this state, a “good” indicator 208 may be set, whereby changeable indicator 209 is set to its dark state. In this way, the consumer may be confident that the product has been sold prior to its expiration date. If at the point-of-sale, however, the product is determined to have expired, then a “bad” indicator 212 is set. Particularly, an electro-chromic material 213 is set to a dark state to indicate that the product has expired. It will be appreciated that the indicator may take many other forms.

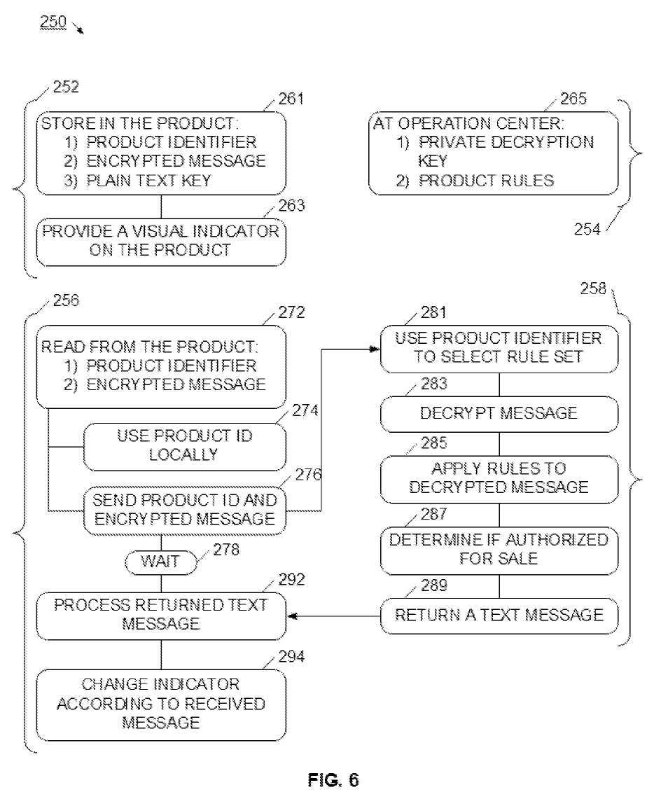

Referring now to FIG. 6, a method for validating and confirming a change of state for a product is illustrated. In method 250, a product identifier, encrypted message, and plain text key are stored in the product as shown in block 261. The product typically has an attached or integrated label that cooperates with an embedded processor, radio, and antenna, or may have packaging for holding the indicator. These data values are typically stored in a memory associated with the embedded processor. A visual indicator is also provided on the product as shown in block 263. In one example, the visual indicator may be similar to the product indicator 200 shown with reference to FIG. 5. The product preparation steps 252 are typically performed by the manufacturer at the time of manufacturing, although these processes may be done by others in the distribution chain. At the operations center 254, information is stored that associates the product identifier with the decryption key necessary to decrypt the stored message. Further, product rules are stored as to when the product may be validly sold as shown in block 265. At the point-of-sale 256 the product is moved adjacent an RF device, where the product identifier and encrypted message is read as shown in block 272. The product ID may be used locally as shown in block 274 to retrieve pricing and inventory information. The product ID and encrypted message are also transmitted to network operations center as shown in block 276. The point-of-sale terminal then waits as shown in block 278, or performs other activities such as payment collection required to conclude the consumer transaction. However, the product will not be confirmed as sellable during the “wait” period.

The network 258 receives the product identifier and selects an appropriate rule to apply as shown in block 281. The product identifier may also be associated with a particular decryption key, and that decryption key may be used to decrypt the message as shown in block 283. In one example, the decrypted message includes an expiration date, and a rule is applied to see if the expiration date has passed as shown in block 285. It will be understood that other rules may be applied. Once the rule has been applied, the network operations center may determine if a sale is authorized in block 287. If the sale is authorized, the network operations center may retrieve a text message associated with the product ID. This product ID has been previously stored, and is the same as the plain text key stored in a secret location at the product. This text message is returned to the point-of-sale terminal as shown in block 289. The point-of-sale terminal transmits the text message to the embedded processor in the product and the embedded processor processes the received text message as shown in block 292. In a simple example, if the returned text message matches the stored plain text key, then the embedded processor is aware that the product may be validly sold. In a similar manner, if the keys do not match, then the product may not be validly sold. Depending on the product state, the embedded processor uses a power supply to change an indicator to show the consumer product state as shown in block 294. For example, the embedded processor may set an electro-chromic material to a state that indicates a product has been validly sold, or alternatively, set the electro-chromic material to a state that shows the product has expired.

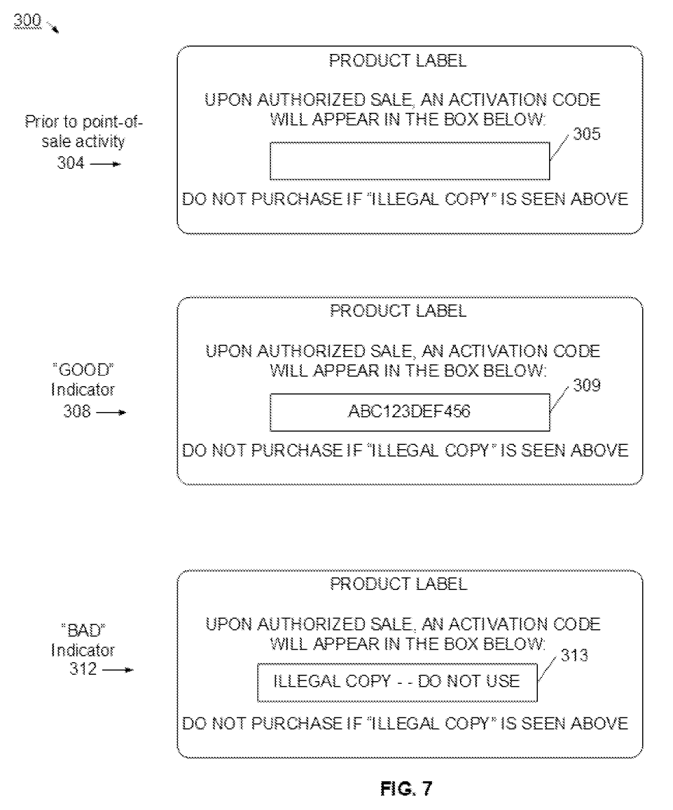

Referring now to FIG. 7, a product indictor 300 is illustrated. Product indicator 300 is similar to product indicator 10 discussed with reference to FIG. 1, and so will not be described in detail. For example, product indicator 300 has an embedded processor, radio, and antenna system as described with FIG. 1. However, product indicator 300 is intended to communicate a software activation code to a consumer provided certain activation rules are met. In this way, the specific rules applied at the network operation center will be different, and different information may be communicated in the encrypted messages. It will be understood that other product indicator labels may be used for other types and classes of products and validation rules.

FIG. 7 shows a product label for attachment or integration with a software product. For example, the product label may be on a disc box, a cardboard display box, or attached or integral to a disc, such as a CD of DVD. Prior to authorized sale, the product label may indicate that the product has not been validly sold, as shown at 304. As shown by empty box 305, no activation code is shown to the consumer. In this way, a consumer that obtains the software will not be able to activate or fully use the software. Further, the manufacturer can control under what conditions the activation code is revealed. The manufacturer can set rules at the network operation center that restricts times, places, and conditions for sale. In a specific example, the manufacturer can set the minimum revision or patch level for a software product. In this way, the manufacturer can restrict sales to current products, and avoid selling or activating older or buggy software. In this latter example, when the software product is scanned at point of sale, a product ID is read, as well as an encrypted message. The encrypted message includes an indication of the software revision number, which is decrypted and extracted at the network operations center. If the software is too old, then the activation code is not reveled. However, if the revision meets rule requirements, and other conditions of sale are met, then the network operation center may send the “good” key code to reveal the activation code.

If the “good” key code is received at the embedded processor for the product, the embedded processor uses local power to set the state of changeable indicator to reveal the activation code, as shown at 308. Here, an electro-chromic material has been changed to reveal code 309. Although the code is shown as textual, it will be appreciated that the code may be alternatively revealed. If the “bad” code is received at the embedded processor for the product, the embedded processor uses local power to set the state of changeable indicator to reveal an “invalid” message, as shown at 313. Here, an electro-chromic material has been changed to reveal an “illegal copy” message. Although the message is shown as textual, it will be appreciated that the message may be alternatively revealed.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A product indicator device, comprising:
a changeable indicator;
an embedded system, comprising:
a radio;
a memory storing validation data;
a power source selectably connectable to the changeable indicator; and
an embedded processor coupled to the radio and operating the steps comprising:
receiving a key code using the radio;
determining a product state using the key code and the validation data; and
applying power to the changeable indicator to change the indicator to indicate the product state.

2. The product indicator device according to claim 1, wherein the changeable indicator is an electro-chromic material.

3. The product indicator device according to claim 1, wherein the product indicator device is in the form of a product label.

4. The product indicator device according to claim 1, wherein the product indicator device is attachable to a product.

5. The product indicator device according to claim 1, wherein the product indicator device is integrally formed with a product.

6. The product indicator device according to claim 1, wherein:
the validation data includes a product ID;
the embedded system has a transmitter for sending the product ID; and
the key code is received responsive to sending the product ID.

7. The product indicator device according to claim 6, wherein:
the validation data includes an encrypted message;
the embedded system has a transmitter for sending the encrypted message; and
the key code is received responsive to sending the encrypted message.

8. The product indicator device according to claim 7, wherein:
the validation data includes a plaintext key value;
the encrypted message includes an encrypted version of the key value; and
the received key code is the plaintext key value.

9. The product indicator device according to claim 1, wherein:
the validation data includes an encrypted message;
the embedded system has a transmitter for sending the encrypted message; and
the key code is received responsive to sending the encrypted message.

10. The product indicator device according to claim 9, wherein:
the validation data includes a plaintext key value;
the encrypted message includes an encrypted version of the key value; and
the received key code is the plaintext key value.

11. The product indicator device according to claim 1, wherein the radio is an RF (Radio Frequency) or NFC (Near Field Communication) device.

12. The product indicator device according to claim 1, wherein the power source is an RF (Radio Frequency) or EM (Electro-Magnetic) power converter.

13. The product indicator device according to claim 1, wherein the power source is a battery.

14. The product indicator device according to claim 1, wherein the product state is a product-expired state or a product-not-expired state.

15. The product indicator device according to claim 1, wherein the product state is indicated by selectively revealing a password or activation code.

16. A method for validating and confirming a product state change, comprising:
retrieving data from an embedded processor associated with a product;
processing the data to confirm that the product may validly have its state changed; and
sending a data key to the embedded processor.

17. The method according to claim 16, wherein the processing step includes using a set of predefined rules.

18. The method according to claim 16, wherein the data includes an expiration date and the set of rules comprises a rule for comparing the expiration date to a current date.

19. The method according to claim 16, wherein the data includes software information and the set of rules comprises a rule for comparing the software information to a set of software requirements.

20. The method according to claim 16, further including the steps of:
receiving the data key at the embedded processor;
processing the received data key with other data stored at the embedded processor;
confirming that the product may validly have its state changed;
receiving power; and
using the power to change an indicator.

21. The method according to claim 20, wherein the indicator is an electro-chromic material.

22. The method according to claim 16, wherein the step of retrieving the data includes using an RF device or an NFC device to read the data.

23. The method according to claim 16, wherein the step of processing the data includes sending the data to a network operations center.

24. The method according to claim 16, wherein the step of sending the data key includes using an RF device or an NFC device to transmit the data key.

25. The method according to claim 16, wherein the processing step includes decrypting at least a portion of the data to extract the data key.

26. The method according to claim 16, wherein retrieving the data includes retrieving a product ID.

27. The method according to claim 16, wherein retrieving the data includes retrieving a message having an encrypted version of the key code.

28. The method according to claim 16, wherein retrieving the data includes retrieving a message having encrypted product information.

29. The method according to claim 16, wherein retrieving the data includes retrieving a message having encrypted expiration or revision information.

30. The method according to claim 16, further including the step of receiving a confirmation message that an indicator on the product has changed.
